(19) United States
(12) Patent Application Publication
(10) Pub. No.: US 2009/0211568 A1
(43) Pub. Date: Aug. 27, 2009

(54) Thermal Storage System

(76) Inventor: Edward J. Whitaker, South Ryegate, VT (US)

Correspondence Address: JAMES MARC LEAS, 37 BUTLER DRIVE, S. BURLINGTON, VT, 05403, US

(21) Appl. No.: 12/390,477

(22) Filed: Feb. 22, 2009

Related U.S. Application Data
(60) Provisional application No. 61/066,718, filed on Feb. 22, 2008.

(51) Int. Cl. F24J 2/34; F24J 2/04; F25B 29/00; B23P 15/26

(52) U.S. Cl. 126/617; 126/646; 126/640; 165/48.2; 29/890.033

(57) ABSTRACT

A thermal storage system includes a porous thermally massive material, a storage fluid, a storage fluid pump, a storage fluid supply system and a storage fluid receiving system. The thermally massive material has a top portion and a bottom portion. The storage fluid supply system is for supplying the fluid to the top portion and the storage fluid receiving system is for receiving the fluid at the bottom portion. The storage fluid exchanges heat with the porous thermally massive material while flowing from the top portion to the bottom portion.

### RELATED APPLICATIONS

This application claims the benefit of provisional patent application 61/066,718 filed Feb. 22, 2008, incorporated herein by reference.

### FIELD

This patent application generally relates to an energy storage system. More particularly, it relates to a system that collects, stores, and provides thermal energy. Even more particularly, it relates to a system that harvests heat or cold from the environment, stores that heat or cold, and provides that heat or cold for space heating or cooling when needed.

### BACKGROUND

Global warming and high costs for carbon based fuel are making large scale harvesting and storage of heat from the environment more attractive. Such systems have included solar collectors that provide a heated fluid to heat a material, such as water that is stored in an insulated tank. The use of high-temperature seasonal thermal stores within individual buildings dates back to at least 1939 when MIT built Solar House #1. The Jenni-Haus, built in 1989 in Oberburg, Switzerland, has three tanks storing 4100 cubic feet of water. The “zero heating energy house,” completed in 1997 in Berlin stores water at temperatures up to 90° C. inside a 700 cubic foot tank in the basement. At the neighborhood level, the Wiggenhausen-Sud development at Freidrichshafen feature a 424,000 cubic foot reinforced concrete thermal store linked to 46,000 square feet of solar collectors to supply 570 houses with around half of their heating and hot water. The Drake Landing Solar Community development in Okotoks, Alberta uses the ground itself as the thermal store, with solar heated water pumped into a borehole thermal energy storage system consisting of 144 boreholes, each 121 feet deep, which heat the ground to a maximum of around 90C.

However, the present applicant recognized that substantial improvement over these schemes has been needed for implementing thermal storage on a large scale, and these improvements are provided in this patent application.

### SUMMARY

One aspect of the present patent application is a thermal storage system, comprising a porous thermally massive material, a storage fluid, a storage fluid pump, a storage fluid supply system and a storage fluid receiving system. The thermally massive material has a top portion and a bottom portion. The storage fluid supply system is for supplying the fluid to the top portion and the storage fluid receiving system is for receiving the fluid at the bottom portion. The storage fluid exchanges heat with the porous thermally massive material while flowing from the top portion to the bottom portion.

Another aspect is a thermal storage system, comprising a porous thermally massive material, a storage fluid, a storage fluid supply plumbing, a storage fluid collector plumbing, and a storage fluid pump. The storage fluid supply system provides the storage fluid for flowing through the porous thermally massive material. The pump and the storage fluid collector plumbing collect the storage fluid that has flowed through the porous thermally massive material and provide the storage fluid for flowing again through the porous thermally massive material.

Another aspect is a thermal storage system that includes a heat exchanger system, a thermally massive material, and a fluid. The heat exchanger system holds the fluid and is immersed in the thermally massive material. The heat exchanger system includes a first tank, a second tank, a first pipe, a second pipe, a third pipe, and a first connector fin. The first tank is connected to the second tank with the first pipe and with the first connector fin. The second pipe is connected to the first tank. The third pipe is connected to the second tank. The thermally massive material has a thermal mass per unit volume that is substantially greater than the thermal mass per unit volume of water.

Another aspect is a thermal storage system, comprising a heat exchanger system, a thermally massive material, and a fluid. The heat exchanger system includes a plurality of storage tanks for holding the fluid. The plurality of storage tanks are immersed in the thermally massive material.

Another aspect is a thermal storage system, that includes a heat exchanger system, a thermally massive material, and a fluid. The heat exchanger system includes a first storage tank, a second storage tank, a first pipe, a second pipe, and a device. The first pipe supplies the fluid to the first storage tank, wherein the second pipe connects the first storage tank and the second storage tank. The device is located for causing a portion of fluid flowing in the first pipe to remain in the first tank and a portion of fluid flowing in the first pipe to be diverted to the second tank.

Another aspect is a heat exchanger system, a thermally massive material, and a fluid. The heat exchanger system includes a plurality of storage tanks and a temperature equalization device, wherein the temperature equalization device controls flow of the fluid to the tanks and from the tanks to about equalize temperature of fluid in the plurality of tanks.

Another aspect is a method of forming a heat exchanger system, that includes determining energy required by a load. The method also includes providing a number of pre-rated heat exchanger modules to satisfy the energy required by the load, wherein the pre-rated heat exchanger modules are for exchanging heat between a thermally massive material and a fluid. The method also includes connecting the number of pre-rated heat exchanger modules and immersing the number of pre-rated heat exchanger modules in the thermally massive material.

Another aspect is a thermal storage system, comprising a heat exchanger system, thermally massive material, and a fluid, The heat exchanger system includes a pre-rated heat exchanger module.

### BRIEF DESCRIPTION OF THE DRAWINGS

The foregoing will be apparent from the following detailed description, as illustrated in the accompanying drawings, in which:

FIGS. 1a and 1b are three dimensional views of one embodiment of the present patent application that includes a thermal storage system that has tanks and pipes for holding a fluid immersed in a thermally massive material;

FIG. 2a is a three dimensional view of the embodiment of FIGS. 1a, 1b in which the fluid is provided at about the same temperature to each of tanks;

FIG. 2b is a side x-ray view of the embodiment of FIG. 2a, showing a diverter for diverting a portion of the fluid flowing in a pipe into one tank while allowing another portion of the fluid to continue on to the next tank in the line of tanks;

FIG. 3 is a three dimensional view of a thermal storage system made of a plurality of pre-rated thermal storage modules;

FIG. 4 is a top view of one embodiment of a pre-rated thermal storage module showing its dimensions;

FIGS. 5a-5c are embodiments of a thermal storage system in which plumbing is provided to circulate fluid throughout the sand;

FIGS. 6a-6d are embodiments of a thermal storage system in which an array of pipes is used to circulate fluid throughout the sand;

FIGS. 7a-7d are embodiments of a thermal storage system in which a heat exchanger is provided embedded in the sand;

FIG. 8a is an embodiment in which a chiller powered by hot water from one thermal storage system provides cold water to another thermal storage system which provides space cooling; and

FIG. 8b is an embodiment similar to the system of FIG. 8a but in which the chiller is powered by electricity or by burning fuel.

### DETAILED DESCRIPTION

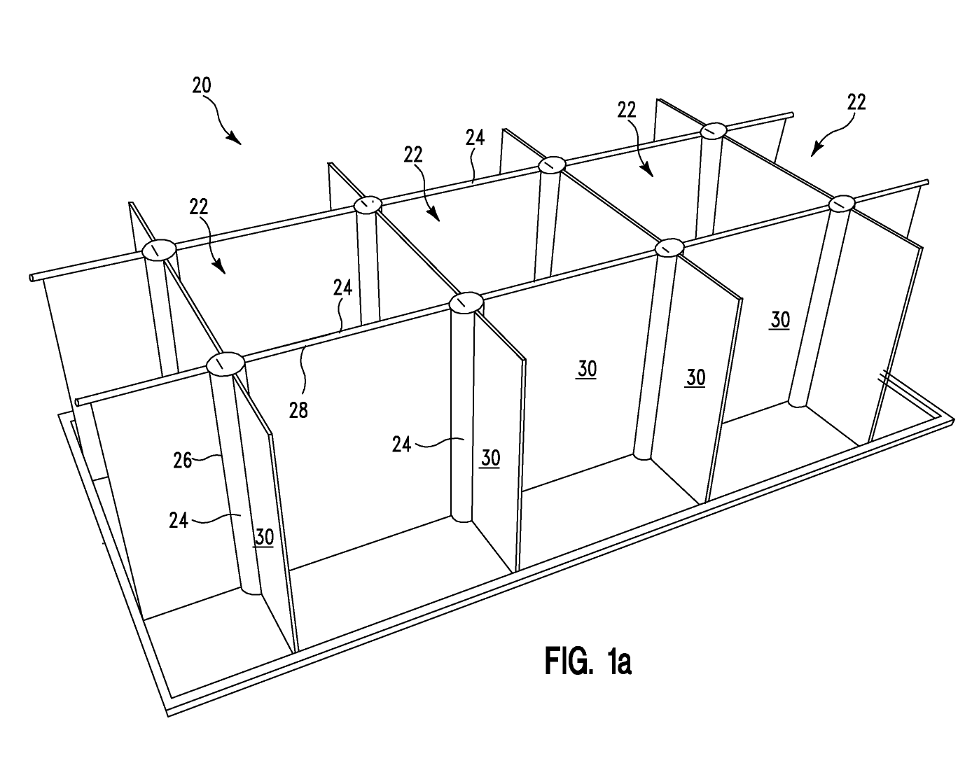

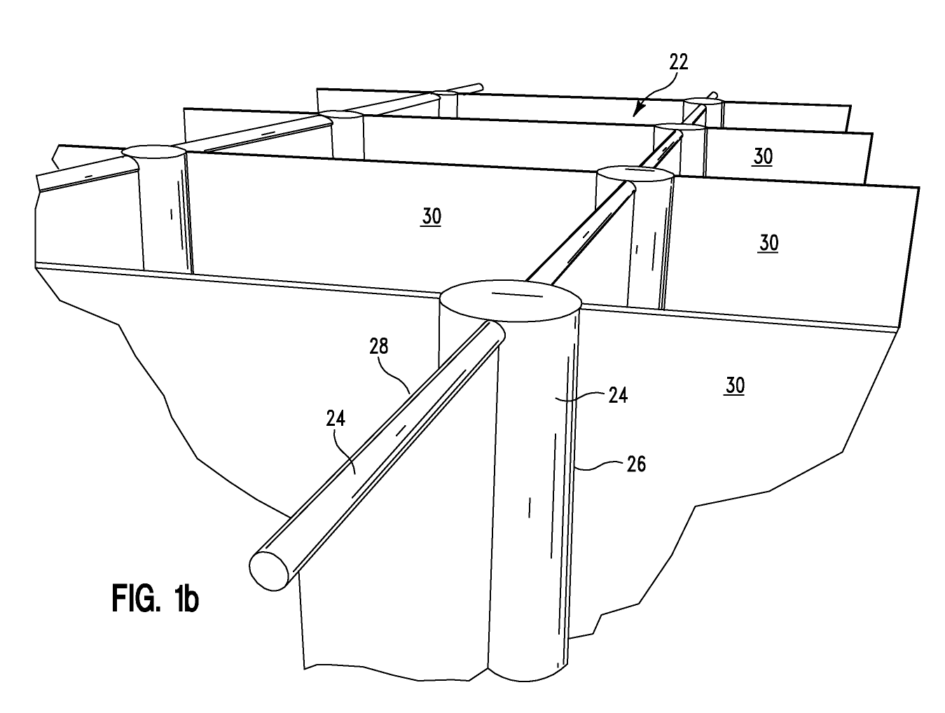

One embodiment of a scheme for thermal storage includes heat exchanger system 20, a thermally massive material, such as sand 22, and fluid 24, as shown in FIGS. 1a, 1b. The thermally massive material can also be a material such as stone, salt, and glass beads. Glass beads can be sourced from broken up waste glass. Thermal storage system 20 includes tanks 26 and pipes 28 that hold the fluid. Thermal storage system 20 is immersed in sand 22. Tanks 26 are connected to each other with pipes 28 and with fins 30. The sand can be dry or damp.

In one aspect the fluid is warmed by a source of heat, such as a solar collector, a biomass boiler, a geothermal source, or waste heat from power generation or from an industrial process, and that heat is transferred to the thermally massive material. In another aspect the fluid warmed by the high thermal mass material transfers that heat to a user of heat, such as a house, a store, an office, a community, a warehouse, or a farm. In the same way, the fluid can be used to cool the thermally massive material from a cold temperature source, such as a winter environment or a refrigeration unit operating off peak or a refrigeration unit or chiller operating from heat from another thermal storage system. The cooled thermally massive material can then later be used to provide cooling for the house. As used in this application, a thermally massive material is a material that has a substantially higher thermal mass per unit volume than water. For example, sand and stones have a density that is almost twice that of water and the thermal mass of a volume of sand is also almost twice that of the same volume of water.

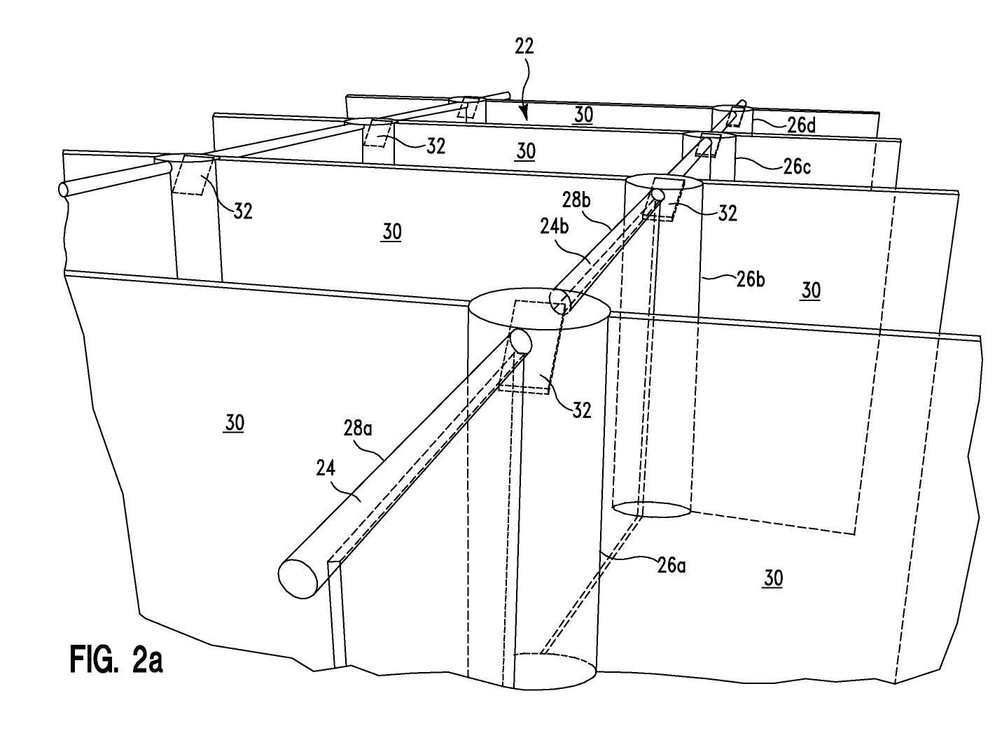

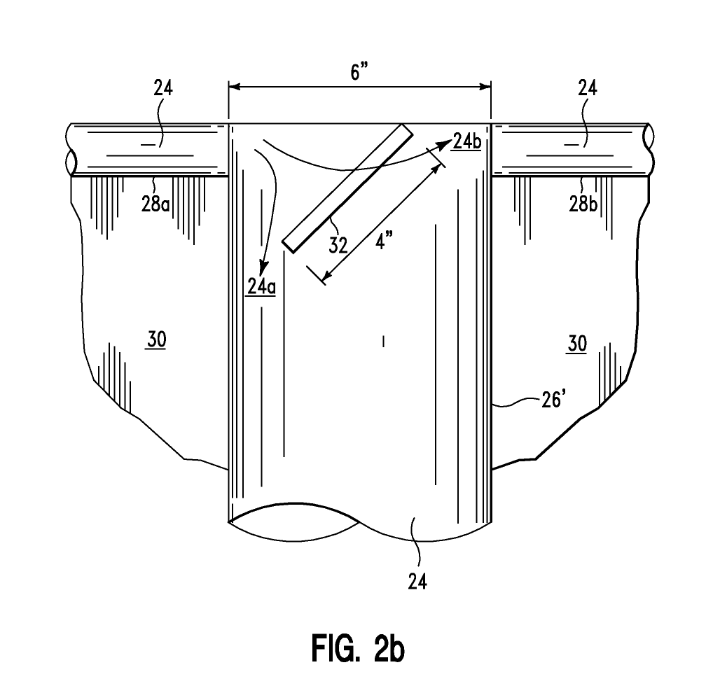

Heat collection efficiency is improved in one embodiment in which fluid 24 is provided at about the same temperature to each of tanks 26a, 26b, 26c, 26d in a line of tanks, as shown in FIG. 2a. In this embodiment heat is also transferred from all of the tanks for use at about the same temperature.

Theoretically, one way this could be done is by providing parallel plumbing so all the tanks receive fluid directly from the same line from the source of heat. The tanks would also feed fluid into a parallel plumbing arrangement to the user of heat so they are all depleted of heat at the same time. However, this parallel arrangement requires a lot of piping.

In another embodiment that simplifies the plumbing, a single plumbing line connects the tanks in sequence, as shown in FIGS. 2a, 2b. Diverter 32 is provided at each tank that directs portion 24a of fluid 24 from pipe 28a to remain in tank 26a while allowing portion 24b of fluid 24 to continue on to the next tank in the line of tanks through pipe 28b, as shown in FIG. 2b. In one embodiment, diverter 32 is mounted inside tank 26a at an angle. Setting the angle of diverter 32 sets the ratio of portion 24a that remains in tank 26a to portion 24b that continues on to the next tank. Thus, tanks in sequence receive fluid that has lost less of its heat along its transit than would be the case if the fluid traveled through each tank 26 in succession.

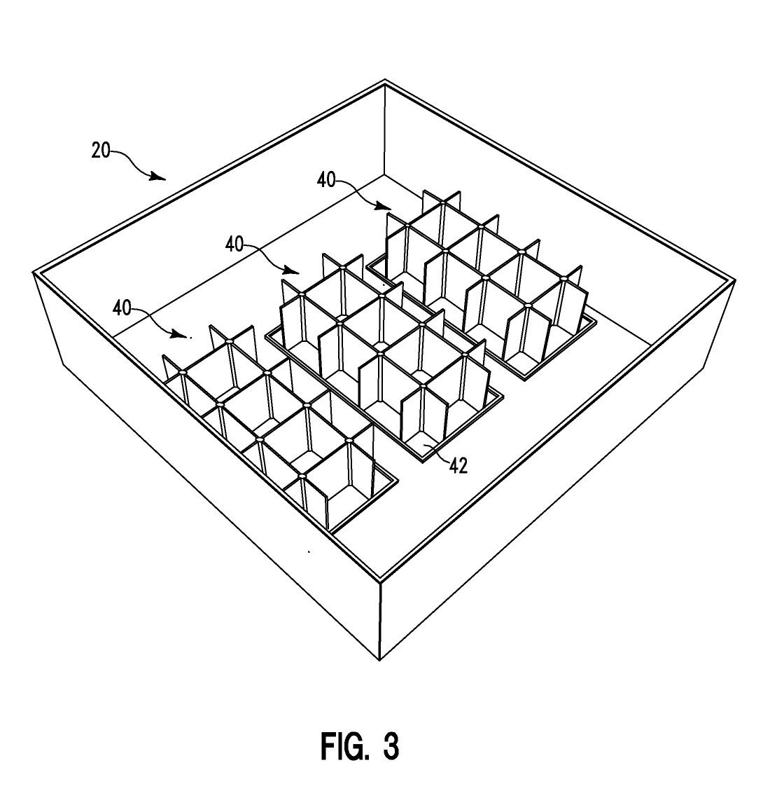

In one embodiment the thermal storage system includes pre-rated heat exchanger modules 40, as shown in FIG. 3. Each module 40 may be factory assembled on pad 42. Module 40 can also be assembled on site using pre-rated sub-components, including tanks 26, pipes 28, and fins 30.

In one embodiment the thermal storage system is fabricated for a particular application first by determining the energy required by a load, for example a house to be heated. The energy may be that required for worst case conditions. Or the present system may be combined with other heating systems, in which case less energy from this system may be required. Next, a number of pre-rated heat exchanger modules are acquired and put in place to satisfy the energy required by the load. Pipes are then used to plumb these pre-rated heat exchanger modules to each other, to the source of heat, and to the load. Then the heat exchanger modules are immersed in the sand or other high thermal mass material. The pre-rated heat exchanger modules can include tanks connected to each other with pipes and fins.

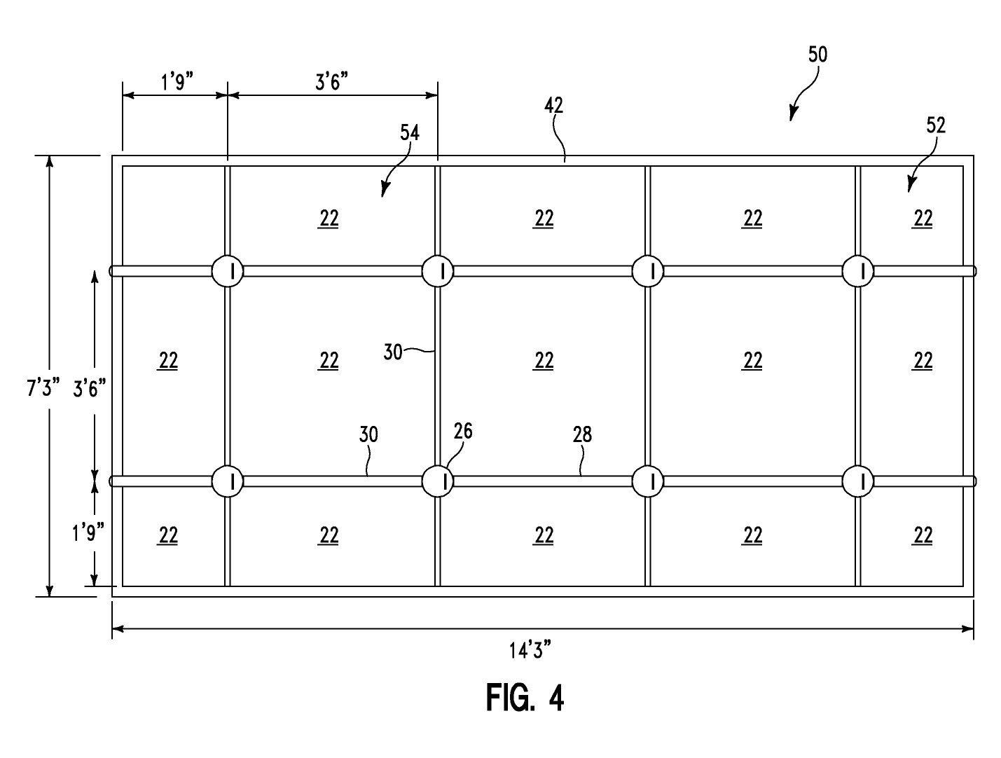

In one embodiment shown in FIG. 4, pre-rated thermal storage module 50 includes tanks 26, pipes 28, and fins 30 that are fabricated of a material that resists corrosion, such as stainless steel or aluminum. A material, such as steel or cast iron, with a corrosion resistant coating, such as a plastic, can also be used. A thermally conductive plastic material can also be used. In one embodiment, tanks 26 are 6 inches in diameter and may be 8 feet tall. Tanks 26 are arranged separated from each other by 3 feet 6 inches in both directions to form array 52 of square sub-units 54 connected by pipes 28 and fins 30. Along edges of array 52 additional fins 30′ extend 1 foot 9 inches from each tank 26. In this example, each module thus has a dimension of 7 feet by 13 feet 6 inches. Pre-rated thermal storage module 50 sits on pad 42 that has a dimension of 7 feet 3 inches by 14 feet 3 inches. All these dimensions can be changed to meet requirements of a particular application. For example, diameter of tanks 26 can be in the range from 6 inches to several feet. Height can be in the range from 2 feet to 16 feet or more for heating very large structures. Spacing between tanks can also be varied from less than 2 feet to 6 feet or more. Fins are sized to provide thermal conduction and transfer between tanks and sand. In one embodiment they may be about ¼ inch thick. The dimensions may be varied for the particular application.

In one embodiment sand 22 is damp. Water mixed with sand 22 facilitates heat transfer throughout sand 22. In addition to water, fluids such as brine, antifreeze, and vegetable oil can be used.

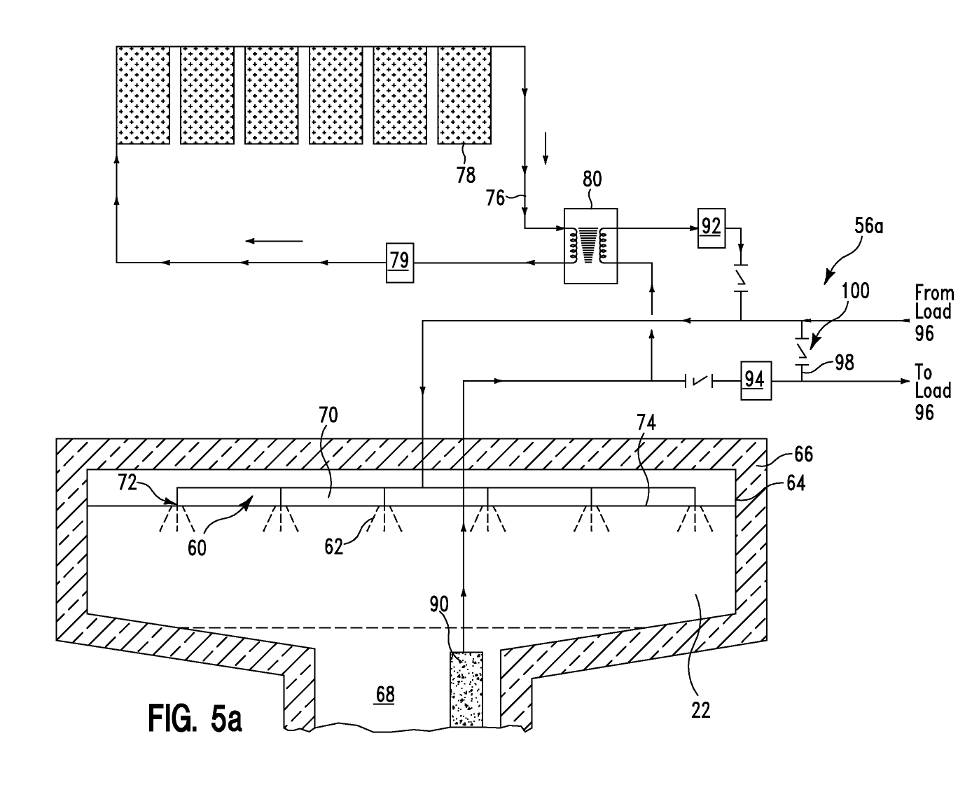

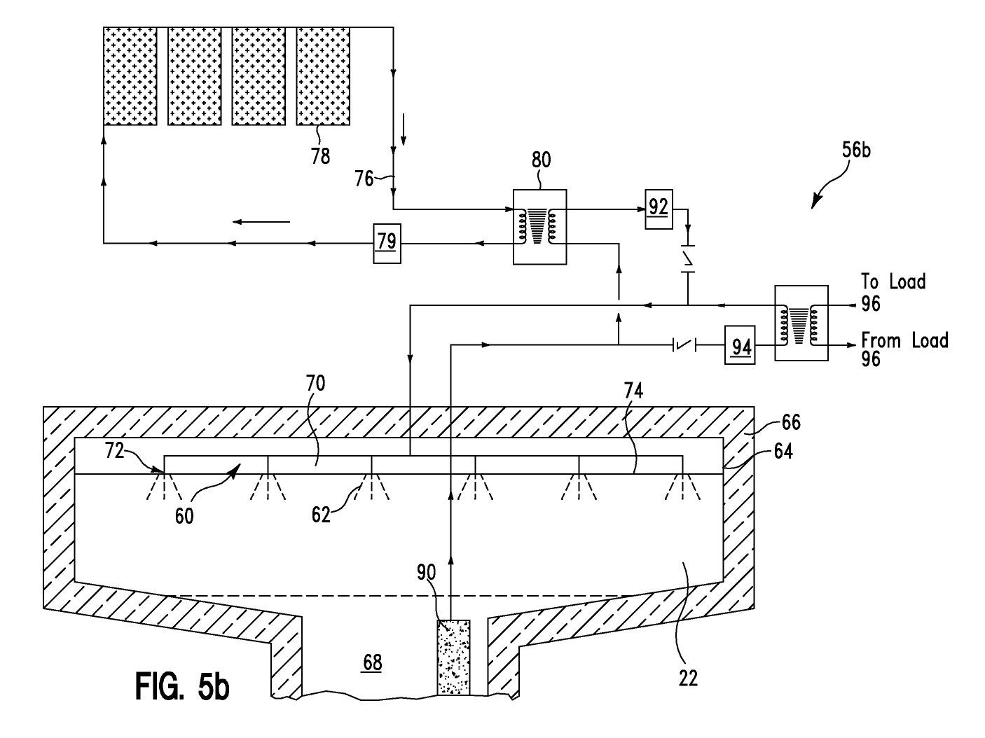

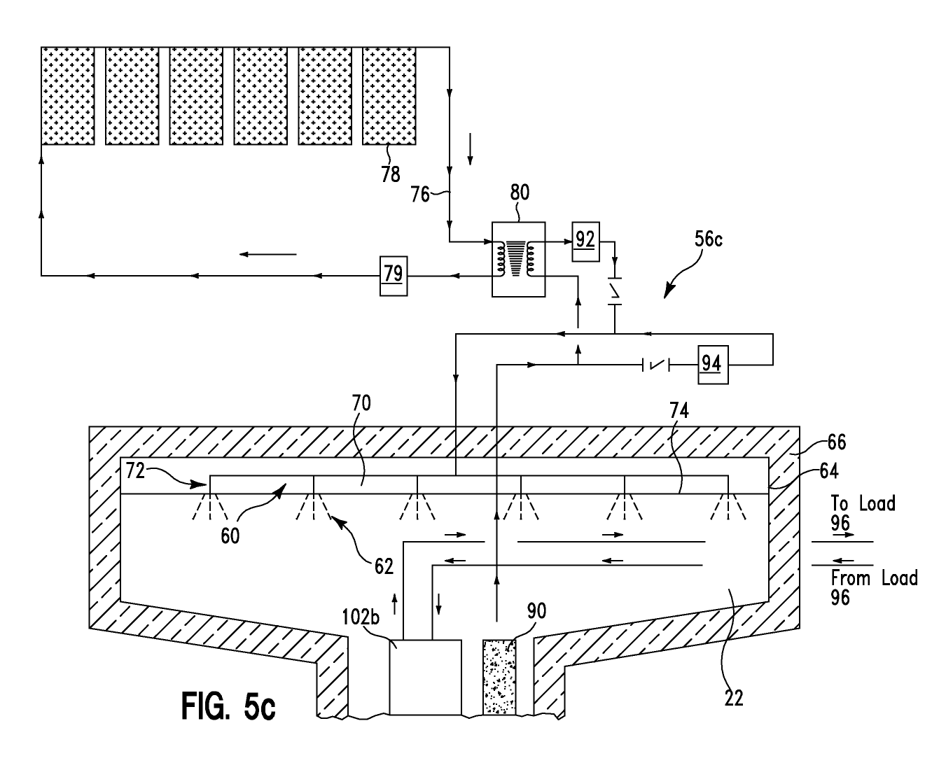

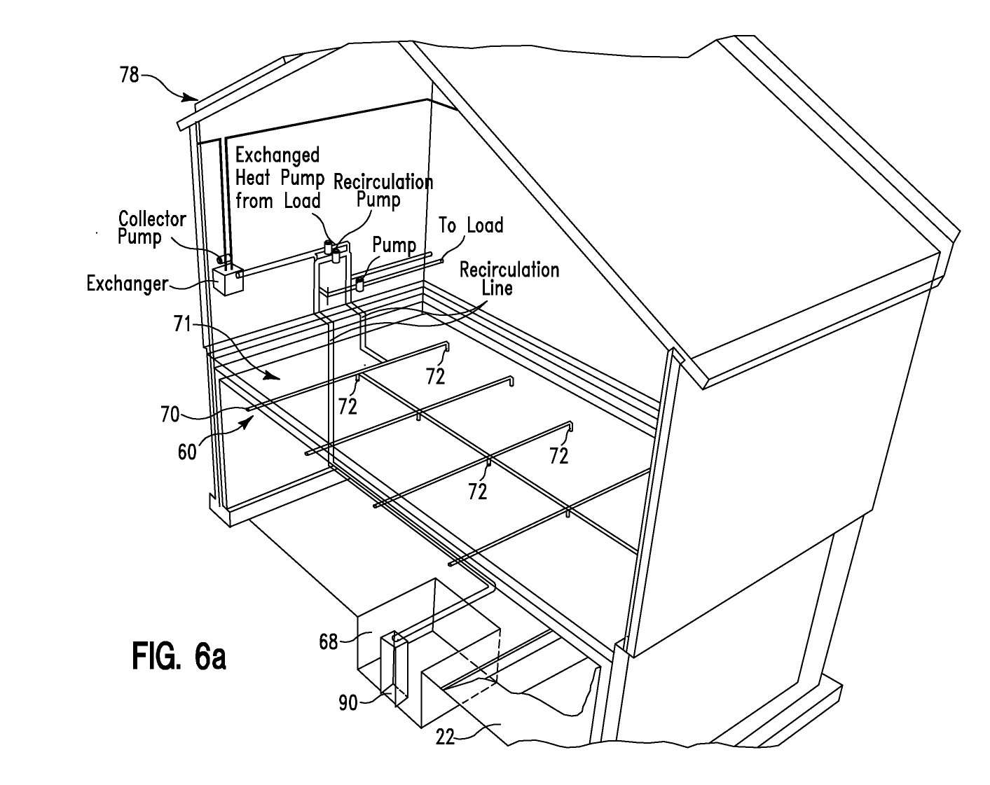

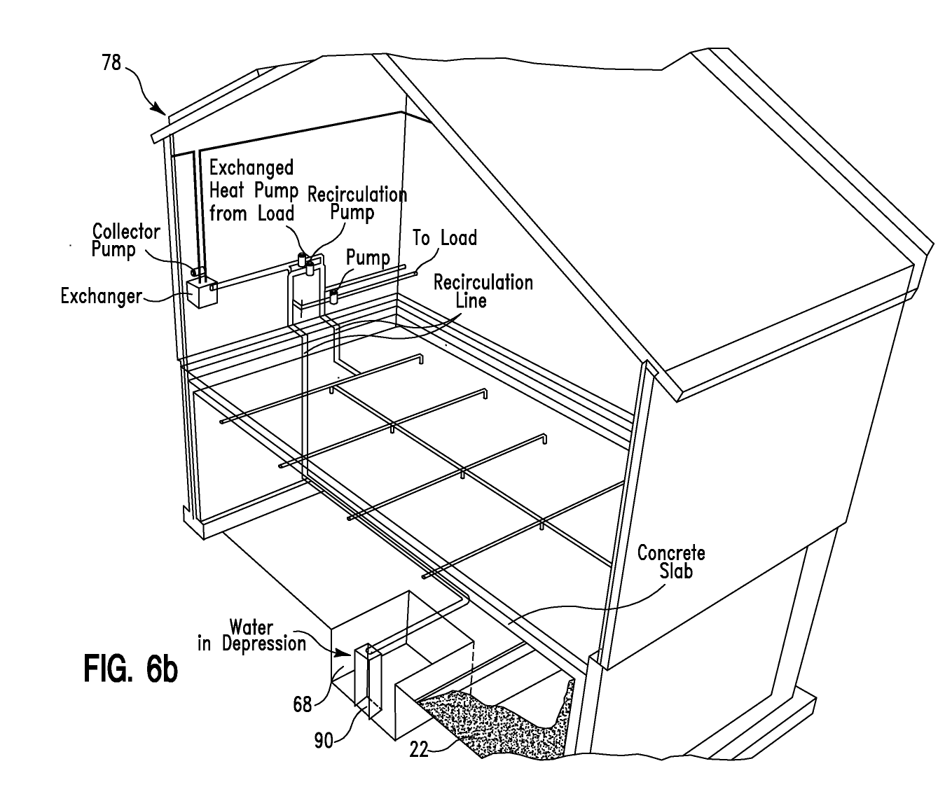

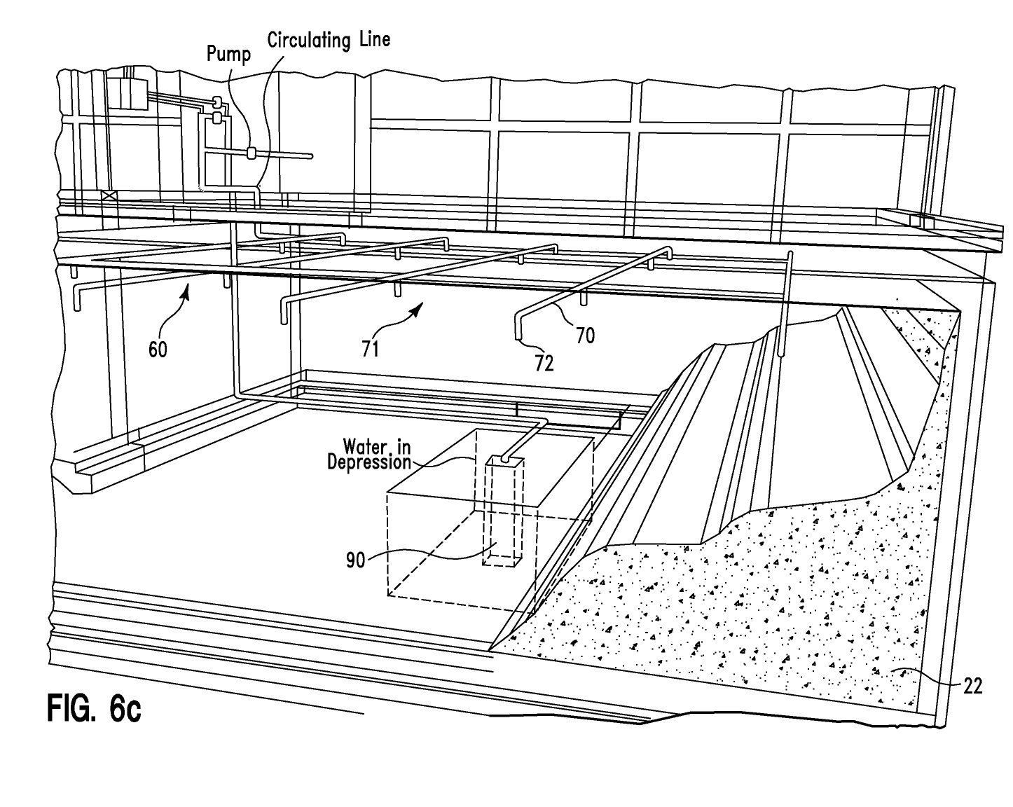

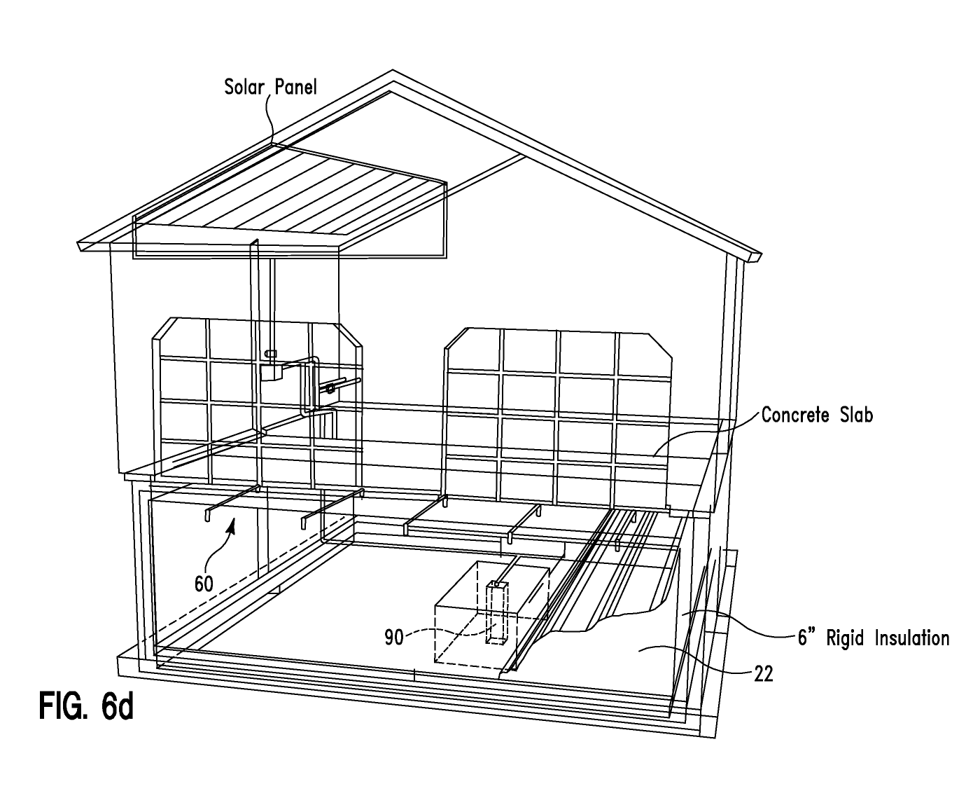

In the embodiments of thermal storage systems 56a, 56b, 56c, plumbing 60 is provided in sand 22, as shown in FIGS. 5a-5c and in FIG. 6-d, to circulate fluid 62 throughout sand 22, facilitating heat transfer to and from all portions of sand 22 and a more uniform temperature throughout sand 22. In these embodiments the volume of fluid 62 is less than 10% of the volume of sand.

In these embodiments water proof lining 64 and thermal insulation 66 are provided to contain fluid 62. The amount of fluid used can be substantially less than would fill space within lining 64. In one embodiment, as heated fluid 62 filters downward through sand 22 it gives off heat to the sand and mixes with fluid coming from other portions of sand 22 in well 68. In one embodiment, movement of fluid 62 through sand 22 facilitates transfer of heat from hotter areas to cooler areas in sand 22, and facilitates transfer of heat from a source of heat, such as a solar collector, to all portions of sand 22, and from all portions of sand 22 to a load, such as a house. This embodiment facilitates effective use of the entire inventory of sand 22 in thermal storage systems 56a, 56b, 56c. In several embodiments, described herein below, fluid 62 is then re-circulated to the top of sand 22, and this recirculation further provides uniform temperature throughout sand 22. Before reentering at the top of sand 22, fluid 62 may be reheated from a source of heat, such as a solar collector.

Plumbing 60 includes pipe 70 with nozzles 72 that spray fluid 62 across top surface 74 of sand 22, as shown in FIGS. 5a-5c and FIGS. 6a-6d, 7a-7d. Nozzles 72 can be pipe ends as shown FIG. 5a. Nozzles 72 can also be holes placed at intervals along a side surface of pipe 70. In on embodiment, pipe 70 is the kind of pipe that has holes, and pipe 70 with holes can be fabricated of plastic. Array 71 of pipes 70 can be used, as shown in FIGS. 6a-6d. Fluid 62 may be warmed from heat provided by collector fluid 76 coming from solar collector 78 as pumped by collector pump 79 and transferred to fluid 62 in heat exchanger 80. The use of heat exchanger 80 allows use of different fluids in solar collector 78 and through sand 22. Fluid 62 warmed from contact with heat exchanger 80 gradually descends through sand 22, giving off its heat to sand 22. Fluid 62 is collected in strainer 90, and pump 92 pumps fluid 62 back up through heat exchanger 80 where it is reheated. Strainer 90 allows fluid to enter but not sand. Other sand filters can also be used. In the embodiment of FIGS. 5a, and 6a-6d, pump 94 also recirculates fluid 62 to load 96 and then back to plumbing 60 and to sand 22 or to heat exchanger 80. Load 96 may be a building, such as a house, office, store, or factory. Pipe 98 and check valve 100 allow for recirculation when load 96 is not drawing flow.

Pipe 98 can be replaced with heat exchanger 102a, as shown in FIG. 5b, which allows use of different fluids through sand 22 and in load 96. With heat exchanger 102a, fluid flowing through load 96 is sand-free. Use of heat exchangers allows for different flow rates in the different systems and for energy savings from use of different sized pumps for each system.

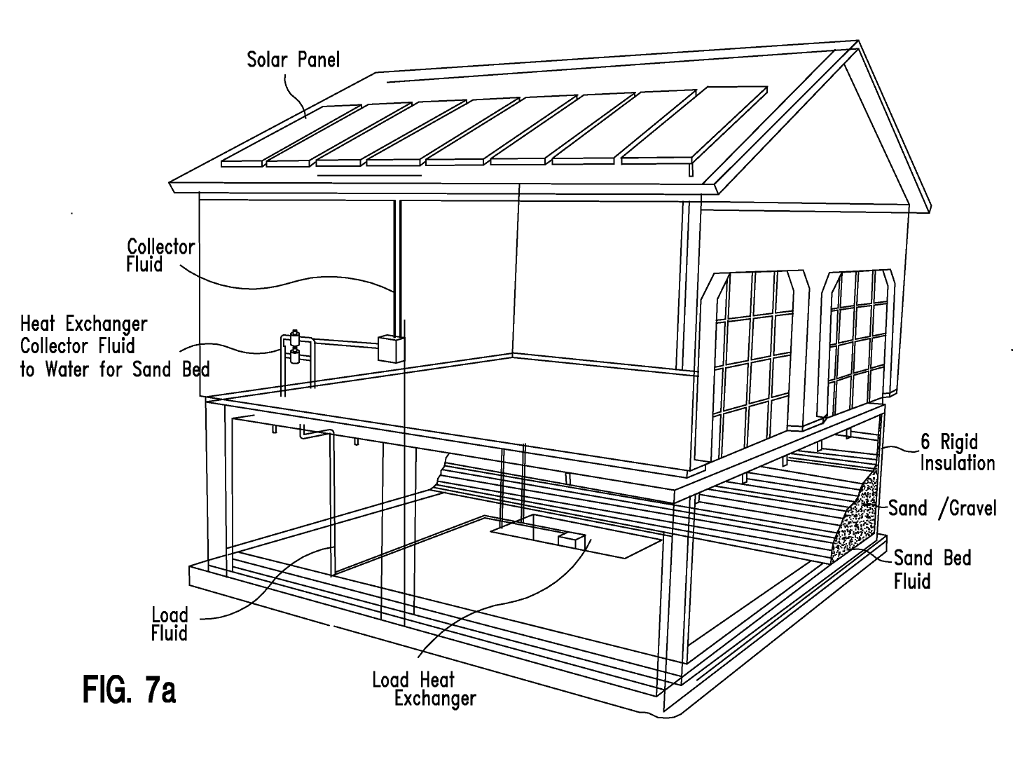

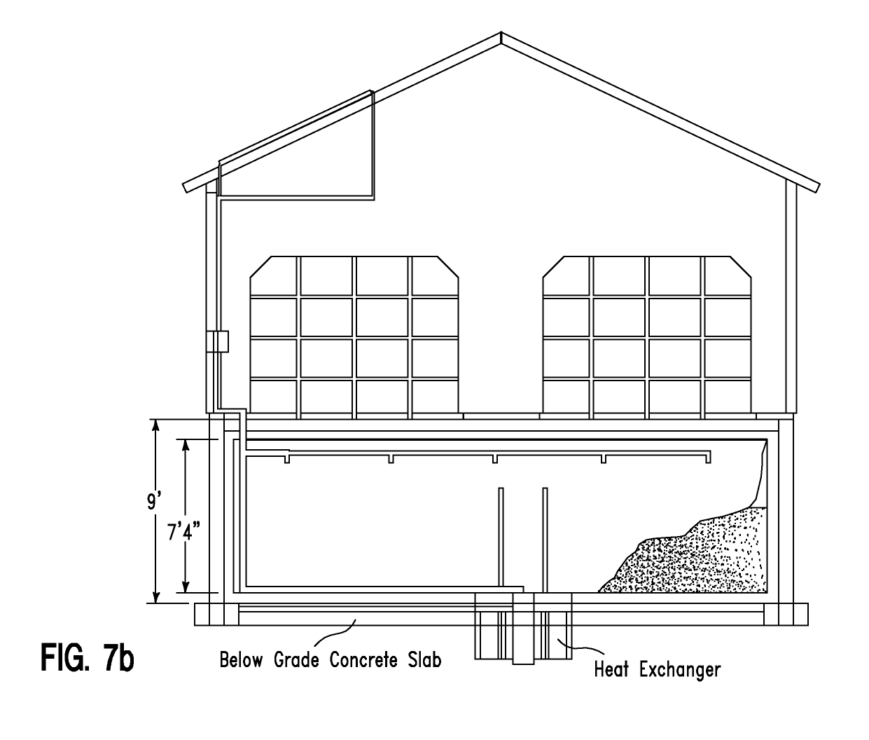

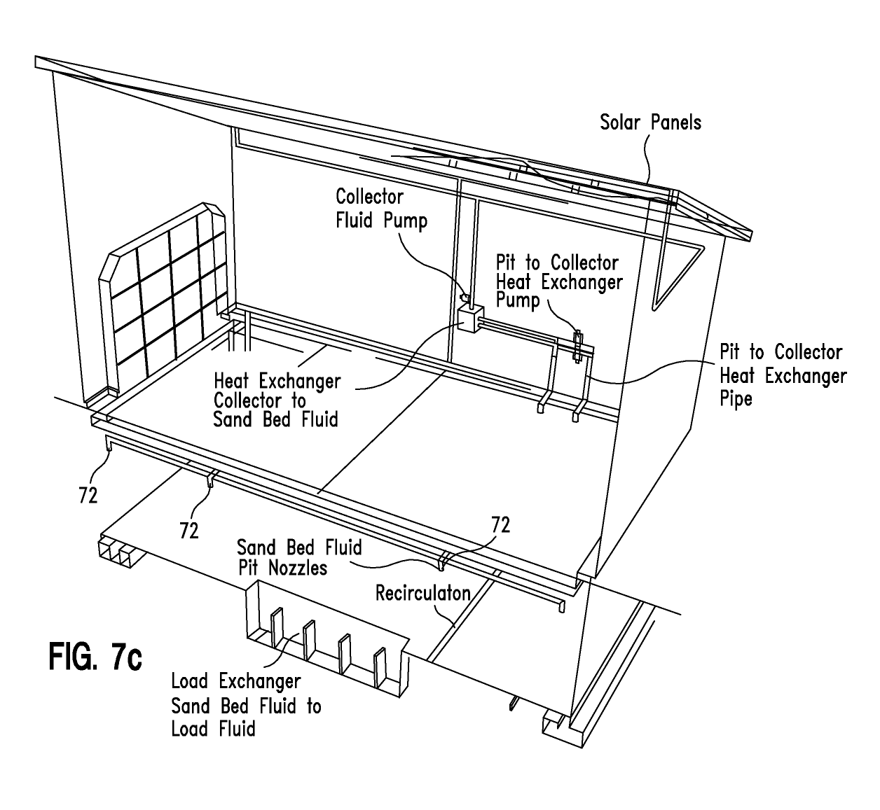

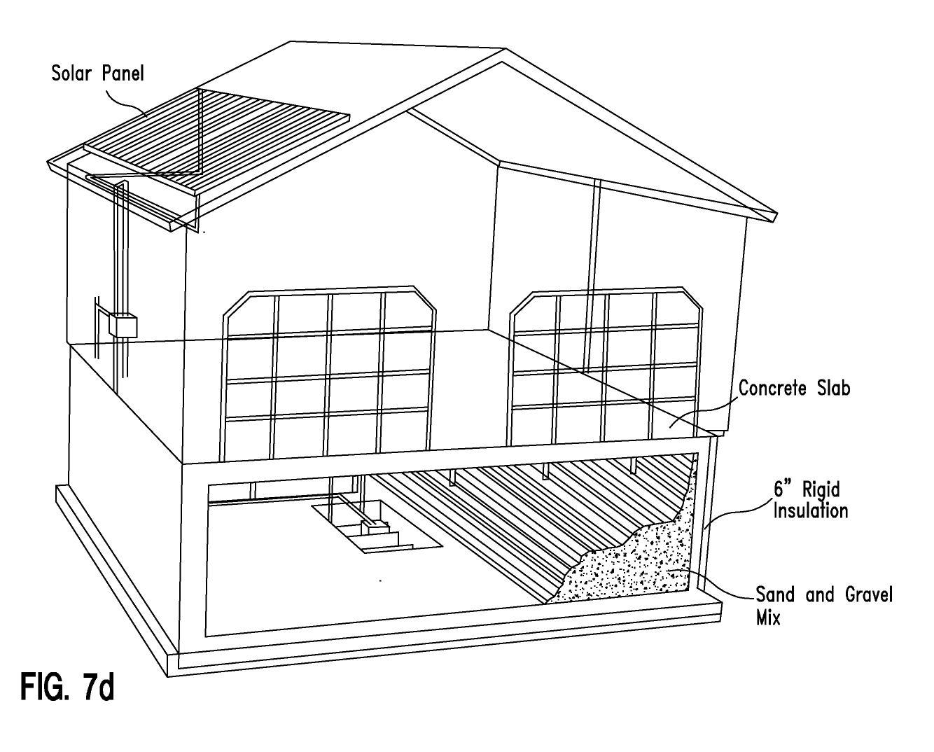

Heat exchanger 102b can be provided embedded in sand 22, as shown in FIGS. 5c and 7a-7d.

A similar arrangement allows sand 22 to provide for cooling load 96. In one embodiment, instead of solar collector 78 providing warm fluid for heating sand 22, collector 78 is exposed to a cold temperature environment which serves as a sink to withdraw heat from sand 22. In this case collector 78 would be shaded from the sun.

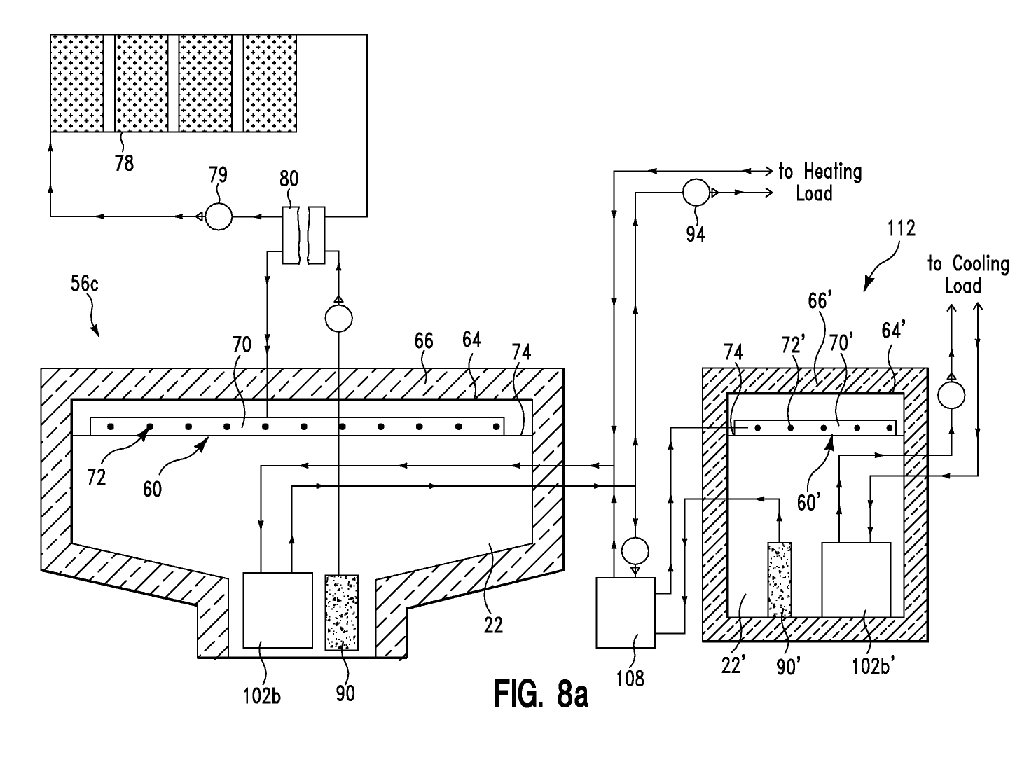

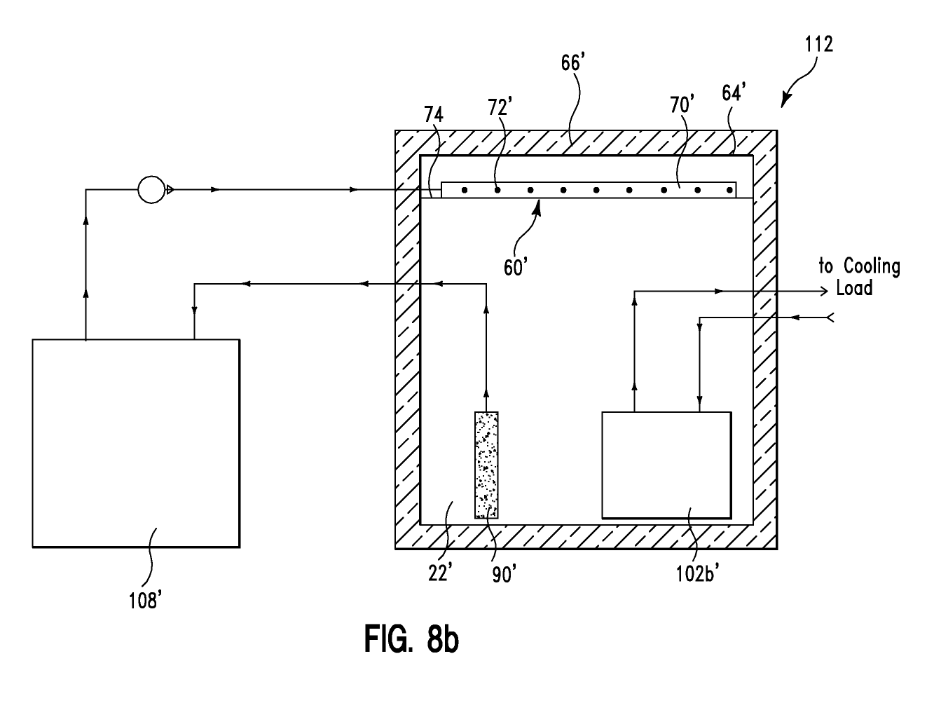

Alternatively, hot water powered chiller 108, such as the nominal 4.5 kW Rotartica 045 or 045V chiller available from Rotartica, Basauri (Bizkaia) Spain, can be powered with hot fluid provided from solar hot water panels or from the above described thermal storage systems 20, 56a, 56b, or 56c, as shown in FIG. 8a. Operation of the Rotartica 045 and 045V models are described in product literature available at http://schroderzimmerly.com/rotartica/Rotartica_Product_Description.pdf

The output of chiller 108 is cold fluid 110. In one embodiment cold fluid 110 is used directly for space cooling. In another embodiment cold fluid 110 is used to cool sand 22′ in another thermal storage system 112 as also shown in FIG. 8a. Cooling of sand 22′ may be accomplished over a period of time, such as during the spring, when substantial solar energy is available but space cooling is not yet needed.

Cold fluid 110 from chiller 108 is introduced through pipe 70′ at the top of a porous or granular thermally massive material, such as sand 22′, and flows down through sand 22′ absorbing heat and cooling sand 22′. Fluid 110 is collected in strainer 90′ at the bottom of thermal storage system 112 and pumped back to chiller 108 to be cooled again. Cooled sand 22′ serves as a thermal reservoir to provide a portion of space cooling to a house, a commercial building, or an industrial building during summer months. It can also serve to provide cooling for an industrial process. In addition, solar collector 78 continues to provide heat to power chiller 108 to provide additional cold water for cooling sand 22′ or to provide direct space cooling. With its large reservoir, thermal storage system 112 provides cold water whenever cooling is required regardless of time of day or availability of the sun. Like thermal storage systems 56a, 56b, 56c, thermal storage system 112 includes nozzles 72′, water proof lining 64′, thermal insulation 66′, and heat exchanger 102b′ embedded in sand 22′. Alternatively, a design like that shown in FIG. 5b can be used in which heat exchanger 102a is located outside sand 22′. A design like that of FIG. 5a can also be used in which fluid 110 flows to the cooling load.

Alternatively, chiller 108′ can be electric or fuel fired, as shown in FIG. 8b. Chiller 108 can also be powered from geothermally heated water, industrial process hot water, or from waste heat from electric power generation.

While the disclosed methods and systems have been shown and described in connection with illustrated embodiments, various changes may be made therein without departing from the spirit and scope of the invention as defined in the appended claims. The examples given are intended only to be illustrative rather than exclusive.

1. A thermal storage system, comprising a porous thermally massive material, a storage fluid, a storage fluid pump, a storage fluid supply system and a storage fluid receiving system, wherein said thermally massive material has a top portion and a bottom portion, wherein said storage fluid supply system is for supplying said fluid to said top portion and wherein said storage fluid receiving system is for receiving said fluid at said bottom portion, wherein said storage fluid exchanges heat with said porous thermally massive material while flowing from said top portion to said bottom portion.

2. A thermal storage system as recited in claim 1, wherein said storage fluid receiving system includes a pump, wherein said storage fluid receiving system provides said storage fluid to said pump for flowing again through said porous thermally massive material.

3. A thermal storage system as recited in claim 2, wherein said storage fluid supply system is connected to a source of heat at a temperature above the temperature of said porous thermally massive material, wherein said storage fluid draws heat from said source of heat and provides said heat to said porous thermally massive material.

4. A thermal storage system as recited in claim 3, wherein said storage fluid receiving system is connected so said received storage fluid receives heat from said source of heat before flowing again through said porous thermally massive material.

5. A thermal storage system as recited in claim 2, wherein said storage fluid supply system is connected to a sink of heat at a temperature below the temperature of said porous thermally massive material, wherein said storage fluid draws heat from said porous thermally massive material and provides said heat to said sink of heat.

6. A thermal storage system as recited in claim 5, wherein said storage fluid receiving system is connected so said received storage fluid provides heat to said sink of heat before flowing again through said porous thermally massive material.

7. A thermal storage system as recited in claim 6, wherein said sink of heat includes a chiller.

8. A thermal storage system as recited in claim 7, wherein said chiller is powered by at least one from the group consisting of electricity and a fuel.

9. A thermal storage system as recited in claim 7, wherein said chiller is powered by a hot fluid.

10. A thermal storage system as recited in claim 9, further comprising a solar collector, wherein said hot fluid is heated by said solar collector.

11. A thermal storage system as recited in claim 9, further comprising a second porous thermally massive material, wherein said hot fluid is heated by said second porous thermally massive material.

12. A thermal storage system as recited in claim 11, further comprising a solar collector, wherein said second porous thermally massive material is heated by said solar collector.

13. A thermal storage system, comprising a porous thermally massive material, a storage fluid, a storage fluid supply plumbing, a storage fluid collector plumbing, and a storage fluid pump, wherein said storage fluid supply system provides said storage fluid for flowing through said porous thermally massive material, wherein said pump and said storage fluid collector plumbing collect said storage fluid that has flowed through said porous thermally massive material and provide said storage fluid for flowing again through said porous thermally massive material.

14. A thermal storage system as recited in claim 13, wherein said storage fluid supply plumbing is connected to a source of heat at a temperature above the temperature of said porous thermally massive material, wherein said storage fluid draws heat from said source of heat and provides said heat to said porous thermally massive material.

15. A thermal storage system as recited in claim 14, wherein said storage fluid collector plumbing is connected so said collected storage fluid receives heat from said source of heat before flowing again through said porous thermally massive material.

16. A thermal storage system as recited in claim 14, further comprising a solar collector, wherein said storage fluid is warmed by heat provided by said solar collector and wherein said porous thermally massive material is for storing said heat.

17. A thermal storage system as recited in claim 16, further comprising a solar collector fluid and a first heat exchanger, wherein said solar collector fluid flows through said solar collector, wherein said first heat exchanger exchanges heat between said solar collector fluid and said storage fluid.

18. A thermal storage system as recited in claim 13, wherein said storage fluid supply plumbing is connected to a sink of heat at a temperature below the temperature of said porous thermally massive material for drawing heat from said porous thermally massive material to said sink.

19. A thermal storage system as recited in claim 13, further comprising a load, a load fluid, and a second heat exchanger, wherein said load fluid flows through said load and through said second heat exchanger, wherein said second heat exchanger exchanges heat between storage fluid and said load fluid.

20. A thermal storage system as recited in claim 19, wherein said second heat exchanger is fully outside said porous thermally massive material.

21. A thermal storage system as recited in claim 19, wherein said second heat exchanger is embedded in said porous thermally massive material.

22. A thermal storage system, comprising a heat exchanger system, a thermally massive material, and a fluid, wherein said heat exchanger system holds said fluid and is immersed in said thermally massive material, wherein said heat exchanger system includes a first tank, a second tank, a first pipe, a second pipe, a third pipe, and a first connector fin, wherein said first tank is connected to said second tank with said first pipe and with said first connector fin, wherein said second pipe is connected to said first tank and wherein said third pipe is connected to said second tank, wherein said thermally massive material has a thermal mass per unit volume that is substantially greater than the thermal mass per unit volume of water.

23. A system as recited in claim 22, wherein said thermally massive material includes at least one from the group consisting sand, stone, salt, and glass beads.

24. A thermal storage system as recited in claim 22, wherein said thermally massive material includes a thermally conductive liquid.

25. A thermal storage system as recited in claim 22, wherein said thermally conductive liquid includes at least one from the group consisting water, antifreeze, and oil.

26. A thermal storage system as recited in claim 22, further comprising a source of heat, wherein said second pipe is further connected for receiving heat from said source of heat and for transferring said heat to said thermally massive material.

27. A thermal storage system as recited in claim 26, wherein said source of heat includes a solar collector.

28. A thermal storage system as recited in claim 22, further comprising a user of heat, wherein said third pipe is further connected for providing heat to said user of heat and for transferring heat from said thermally massive material to said user of heat

29. A thermal storage system as recited in claim 28, wherein said user of heat includes at least one from the group consisting of a living space, a store, an office, a community, a warehouse, and a farm.

30. A thermal storage system as recited in claim 22, further comprising a third tank, a fourth tank, a fourth pipe, a second connector fin, a third connector fin, and a fourth connector fin, wherein said second tank is connected to said third tank with said second connector fin, wherein said third tank is connected to said fourth tank with said fourth pipe and with said third connector fin, wherein said fourth tank is connected to said first tank with said fourth connector fin to provide a unit structure.

31. A thermal storage system as recited in claim 30, wherein said heat exchanger system further includes a plurality of said unit structures, plumbed to each other.

32. A thermal storage system as recited in claim 22, wherein said heat exchanger system provides fluid at about the same temperature to each said tank.

33. A thermal storage system as recited in claim 32, wherein each said tank includes a device to provide fluid at about the same temperature to each said tank.

34. A thermal storage system as recited in claim 33, wherein said device diverts a portion of flow to remain in said tank and another portion to another tank.

35. A thermal storage system as recited in claim 34, wherein said device includes a diverter.

36. A thermal storage system, comprising a heat exchanger system, a thermally massive material, and a fluid, wherein said heat exchanger system includes a plurality of storage tanks for holding said fluid, wherein said plurality of storage tanks are immersed in said thermally massive material.

37. A thermal storage system, comprising a heat exchanger system and a fluid, wherein said heat exchanger system includes a first storage tank, a second storage tank, a first pipe, a second pipe, and a device, wherein said first pipe supplies said fluid to said first storage tank, wherein said second pipe connects said first storage tank and said second storage tank, wherein said device is located for causing a portion of fluid flowing in said first pipe to remain in said first tank and a portion of fluid flowing in said first pipe to be diverted to said second tank.

38. A thermal storage system, comprising a heat exchanger system and a fluid, wherein said heat exchanger system includes a plurality of storage tanks and a temperature equalization device, wherein said temperature equalization device controls flow of said fluid to said tanks and from said tanks to about equalize temperature of fluid in said plurality of tanks.

39. A thermal storage system as recited in claim 38, wherein said temperature equalization device includes a turbulence causing element.

40. A thermal storage system as recited in claim 38, wherein said temperature equalization device includes a diverter.

41. A method of forming a heat exchanger system, comprising:
a. determining energy required by a load;
b. providing a number of pre-rated heat exchanger modules to satisfy the energy required by said load, wherein said pre-rated heat exchanger modules are for exchanging heat between a thermally massive material and a fluid;
c. connecting said number of pre-rated heat exchanger modules; and
d. immersing said number of pre-rated heat exchanger modules in said thermally massive material.

42. A method as recited in claim 41, wherein said pre-rated heat exchanger module includes a plurality of fluid storage tanks immersed in said thermally massive material.

43. A thermal storage system, comprising a heat exchanger system, thermally massive material, and a fluid, wherein said heat exchanger system includes a pre-rated heat exchanger module.

44. A thermal storage system as recited in claim 43, wherein said pre-rated heat exchanger module is for exchanging heat between said thermally massive material and said fluid.

45. A thermal storage system as recited in claim 44, wherein said pre-rated heat exchanger module includes a plurality of fluid storage tanks immersed in said thermally massive material.
